(19) United States
(12) Patent Application Publication
(10) Pub. No.: US 2007/0068084 A1
(43) Pub. Date: Mar. 29, 2007

(54) Vertically-movable door

(76) Inventor: Michael R. McClendon, Philadelphia, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 11/355,560

(22) Filed: Feb. 16, 2006

Related U.S. Application Data
(60) Provisional application No. 60/721,227, filed on Sep. 28, 2005.

(51) Int. Cl. E06B 1/70

(52) U.S. Cl. 49/468

(57) ABSTRACT

A door assembly having a door that can be vertically positioned up or down through a floor to totally or partially close off access between rooms or sections of a structure. Door position is controlled by a pulley-cable counterweight configuration, including a motor assist, and all of which are self-contained.

### BACKGROUND OF THE INVENTION

1. Field of Invention

This invention relates to a door device, and more particularly, to a door that slides/drops down below a structure surface (e.g., a floor surface).

2. Description of Related Art

Where space is limited, or where the movement of a door interferes with the flow of people through hallways, one solution has been to use what is known in the art as “pocket doors.” A pocket door is a door that slides sideways into a “pocket” in the adjacent wall.

Examples of such doors are shown in U.S. Pat. Nos. 4,742,645 (Johnston); 6,250,016 (Gravel); 6,823,927 (Steel, et al.); and 6,938,375 (Duncan, et al.).

However, there remains a need to provide a door that slides down through a floor where the associated doorway provides a transition between an upper and a lower floor, e.g., a basement floor.

All references cited herein are incorporated herein by reference in their entireties.

### BRIEF SUMMARY OF THE INVENTION

A door assembly adapted for installation in a structure (e.g., a house, building, etc.) having an upper floor and a lower floor. The door assembly comprises: a housing that extends between the upper floor and the lower floor and anchored to the structure; and a door that is displaceable within the housing so that it can be moved between the upper floor and the lower floor (e.g., between an upper floor and a basement, or between an attic and a lower level, etc.).

A method for providing a vertically moving door in a structure (e.g., a house, building, etc.). The method comprises the steps of: providing a housing having a door that is slidable therein; and installing the housing between an upper floor of a structure and a lower floor of the structure (e.g., between an upper floor and a basement, or between an attic and a lower level, etc.).

### BRIEF DESCRIPTION OF SEVERAL VIEWS OF THE DRAWINGS

The invention will be described in conjunction with the following drawings in which like reference numerals designate like elements and wherein:

FIG. 1 is an isometric view of the present invention, shown partially, installed between floors of a structure;

FIG. 2 is a side cross-sectional view of the present invention installed at a doorway between an upper floor and a lower floor accessed by a stairwell and taken along line 2-2 of FIG. 1;

FIG. 3 is a cross-sectional view of the present invention taken along line 3-3 of FIG. 1;

FIG. 4 is a top cross-sectional view of the present invention taken along line 4-4 of FIG. 3;

FIG. 5 is a cross-sectional view of the counterweight and pulley of the present invention taken along line 5-5 of FIG. 3; and

FIG. 6 provides a partial cross-sectional view of a door latch mechanism to assist retrieval of the movable door once concealed.

### DETAILED DESCRIPTION OF THE INVENTION

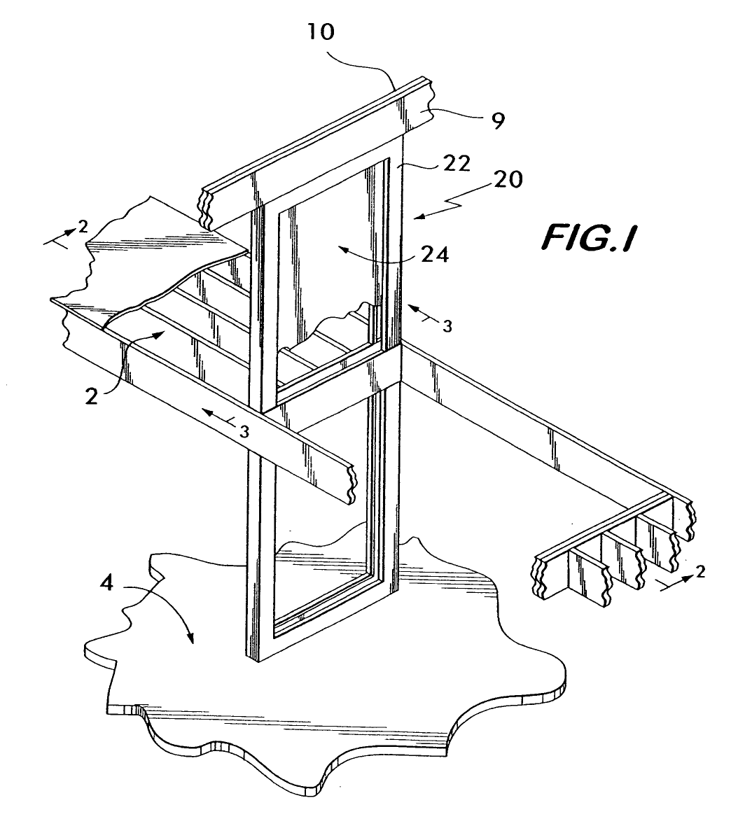

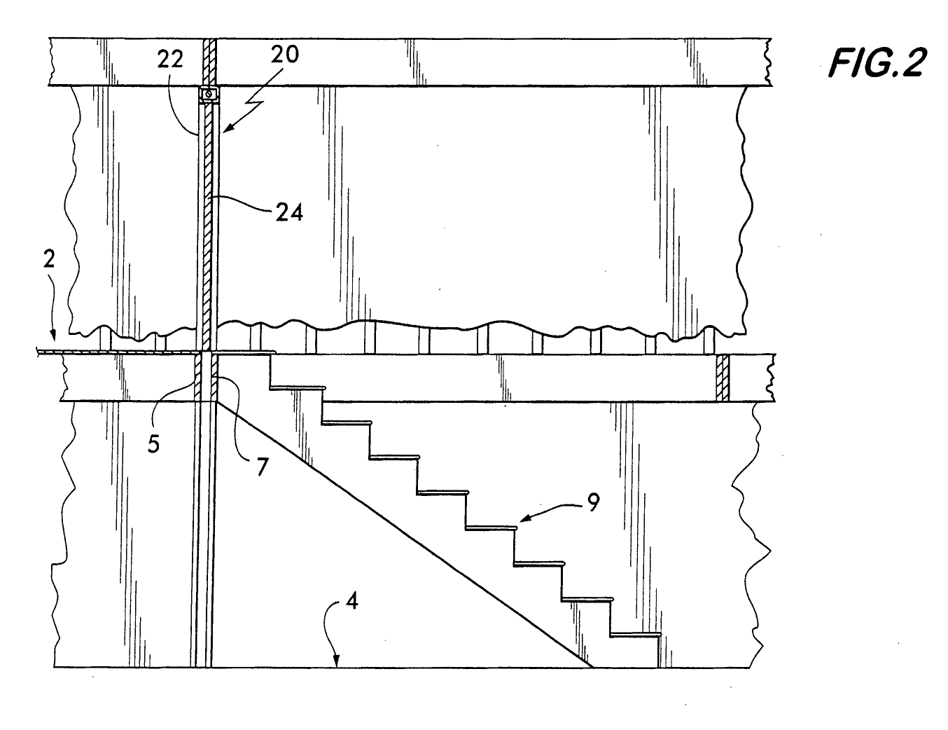

FIG. 1 depicts the present invention 20 which comprises a door assembly that is positioned between an upper floor 2 and a lower floor 4. The door assembly 20 comprises a door track unit 22 and a door 24 that is slidable within the door track unit 22 in a vertical direction. As shown most clearly in FIG. 2, the door assembly 20 is installed in gap between floor joists 5 and 7, just in front of a stairwell 9. In particular, FIGS. 1-2 depict the door 24 in a closed position, thereby preventing access from the upper floor 2 to the stairwell 9. Thus, where space is limited in an area (or areas) or even at an exterior doorway of a structure, the present invention 20 eliminates the need to install a conventional hinged door that requires sufficient clearance in the immediately adjacent vicinity in order to swing open or closed.

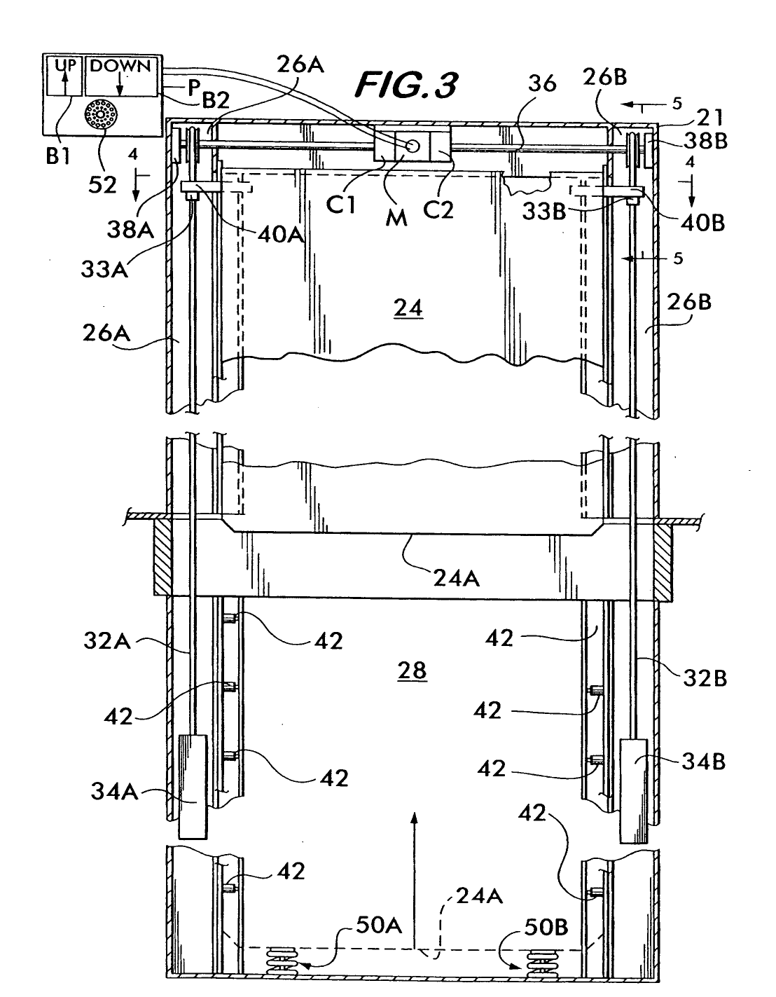

As shown most clearly in FIG. 3, the door assembly 20 comprises a self-contained housing 21 that uses a pair of pulleys and counterweights coupled to the door 24. The term “self-contained” means that the entire door assembly 20 can be installed in a structure (e.g., a house, building, etc.) without the need to obtain access to the components (which will be discussed below in further detail) of the door assembly 20. However, it should be understood that a user can make direct contact with the door 24 itself to manually move it upward or downward.

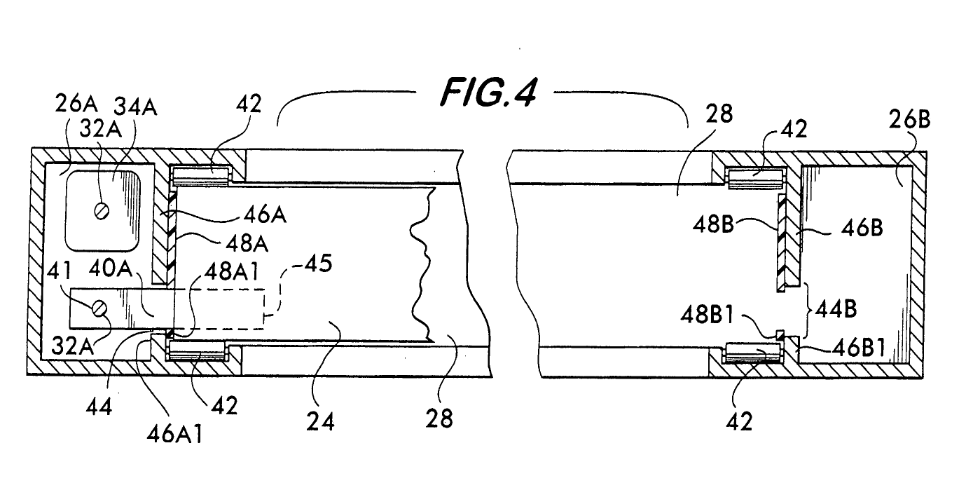

In particular, the door assembly 20 comprises two counterweight channels 26A and 26B on each side of a door channel 28 (which can be most clearly seen in FIG. 4). Each counterweight channel comprises a pulley (30A and 30B, respectively), a cable (e.g., twisted steel cable, 32A and 32B, respectively) and a counterweight (e.g., a cast weight, 34A and 34B, respectively). A common axle 36 couples the pulleys 30A and 30B together and each end of the axle 36 is received in axle journals 38A and 38B. The door 24 is coupled to the respective cables 32A and 32B via respective coupling members 40A and 40B. As seen most clearly in FIG. 4, one end of the coupling member 40A comprises a hole 41 through which the cable 32A passes and which is fixed to the cable 32A through a fastener or crimp (33A and 33B, respectively); the other end 45 of the coupling member 40A is anchored inside the door 24. Together, the counterweights 34A and 34B are matched to the weight of the door 24. Thus, movement and position of the door 24 is achieved by pushing the door 24 upward, thereby causing the counterweights 34A and 34B to move downward and vice versa. Because of the presence of the counterweights 34A/34B, the user can position the door 24 at any desired vertical position, e.g., fully upward, fully downward, half-way up, a quarter of the way up, etc. by simply placing their hand against the door 24 and displacing it upward or downward. In other words, once the user stops applying an upward (or a downward) force, the door 24 stops in place.

To assist the door 24 in remaining aligned as it moves upward or downward and prevent skewing/jamming, a plurality of rollers 42 are provided on each side of the door 24. These rollers 42 guide the door 24 during its movement.

FIG. 4 depicts a cross-sectional view of the door assembly 20 which depicts the door 24 in partial. As can be seen in that figure, the door channel 28 is located between the two counterweight channels 26A and 26B. Each channel 26A and 26B is nearly totally closed off from the door channel 28 except for a gap (44A and 44B respectively). The gaps 44A/44B permit the coupling members 40A/40B to carry the door 24 up and down. To prevent the door 24 from riding directly against channel walls 46A and 46B, respective rub rails (e.g., plastic) 48A and 48B are provided along the length of the door channel 28. Second rub rails 48A1 and 48B1 are provided along sub-channel walls 46A1 and 46B1 respectively to serve the same purpose. As can also be seen most clearly in FIG. 4, the rub rails 48A, 48A1, 48B and 48B1 jutt out from their respective channel walls to prevent their respective coupling members 40A and 40B from also rubbing against the channel walls directly at the gaps 44A and 44B.

To cushion that bottom of the door 24 against impact with the bottom of the housing 21, springs 50A and 50B (FIG. 3) are provided at the housing bottom to act as shock absorbers.

Because the present invention is self-contained, the housing 22 is installed in the structure as a unit without the need to have access to the internal components (e.g., the counterweights, pulleys, cables, coupling members, etc.). Although not shown, the present invention 20 is secured or anchored to the structure at joists 5 and 7, to the lower floor 4 and to ceiling joists 9 and 10 (FIG. 1). Once the present invention 20 is installed, if the door 24 is slid completely downward into the lower portion of the door channel 28 (see dotted line in FIG. 3 indicating the bottom surface 24A of the door 24), the user can go to the lower floor 4 and push the door 24 upward. Alternatively, a tether or other flexible member (not shown) can be coupled to the door 24 and exposed at the top portion of the door 24 to permit the user to pull the door 24 upward from the bottom portion of the door channel 28.

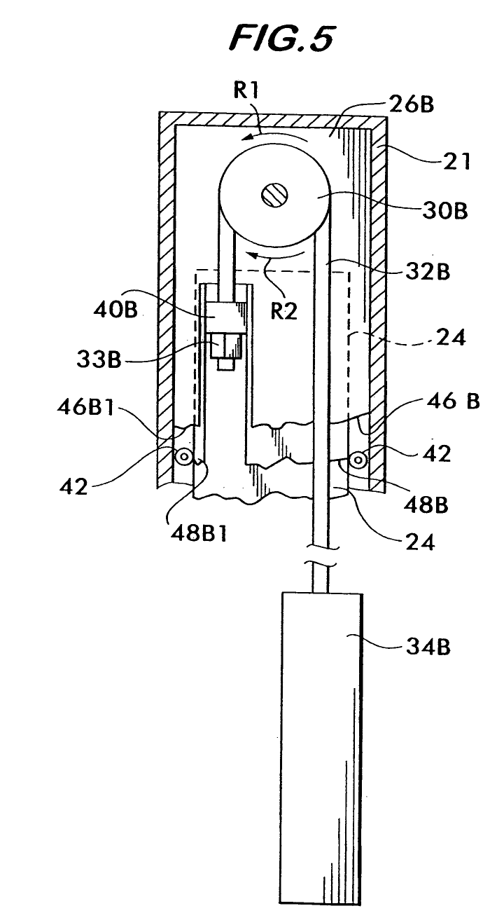

To also assist the user in opening or closing the door 24, a motor M having clutches C1 and C2 are interfaced with the axle 36, as shown in FIG. 3. When the motor M is energized, the clutches C1 and C2 engage the axle 36 while rotating the axle 36 either in a counterclockwise direction R1 (see FIG. 5) to lower the door 24 or in a clockwise direction R2 to raise the door 24. Should power to the motor M ever be removed (e.g., power outage), the clutches C1 and C2 remain disengaged from the axle 36, thereby allowing a person to manually raise or lower the door 24. A control panel P can be mounted adjacent the door assembly 20, on the upper floor 2 and the lower floor 4, which controls the activation of the motor M. The panel can include a “down” button that provides energization current from the structure (house, building, etc.) service panel to the motor M in a first direction to engage the clutches C1 and C2 while rotating the axle 36 in the direction R1; similarly, an “up” button would provide energization current in the opposite direction to the motor M to engage the clutches C1 and C2 while rotating the axle in the direction R2. These buttons can be momentary switches B1 and B2 that permit the user to position the door 24 at any desired position, i.e., as long as the user is depressing the appropriate button (up or down) the door 24 moves in the according direction but as soon as the user no longer depresses the button, the motor M is de-energized and the door 24 stops in place. Thus, the user can position the door 24 totally closed, half-way closed, quarter closed, etc.

Other variations of the present invention 20 include a voice activation (see microphone 52, including sound processor and motor driver electronics, not shown) of the motor M whereby the user can command the motor M based on specified commands of up or down. Alternatively, a foot-activated switch can be used with the motor M to position the door 24 at the desired location.

It should be understood that the placement of the door assembly 20 is not limited to a doorway to a stairwell. The door assembly 20 can serve as a doorway between any two locations in a structure as long as there is space beneath one floor of the structure to permit the door assembly 20 to be positioned therein. As a result, although all of the figures depict the door assembly 20 being positioned such that the upper portion of the door assembly 20 acts as the door to a stairwell 9 (or room, etc.), it is within the broadest scope of the present invention to have the door assembly 20 installed in the structure such that the lower portion of the door assembly 20 acts as the door; for example, the door assembly 20 could be installed such that the upper portion of the door assembly is located in an attic (or a higher floor, or otherwise suspended from an location) and the lower portion of the door assembly 20 is positioned to form the doorway to the stairwell 9 (or room, etc.). Moreover, where possible, the present invention 20 can even be used as a door for gaining access into the structure from the outside environment.

The door track unit 22 is anchored to the structure (e.g., joists, flooring, concrete, etc.) using any conventional means known in the art but without interfering with the door 24 or counterweight 34A/34B motion.

As mentioned earlier, if the door 24 is slid completely downward into the lower portion of the door channel 28 (see dotted line in FIG. 3 indicating the bottom surface 24A of the door 24), the user can go to the lower floor 4 and push the door 24 upward, or alternatively, a tether or other flexible member (not shown) can be provided.

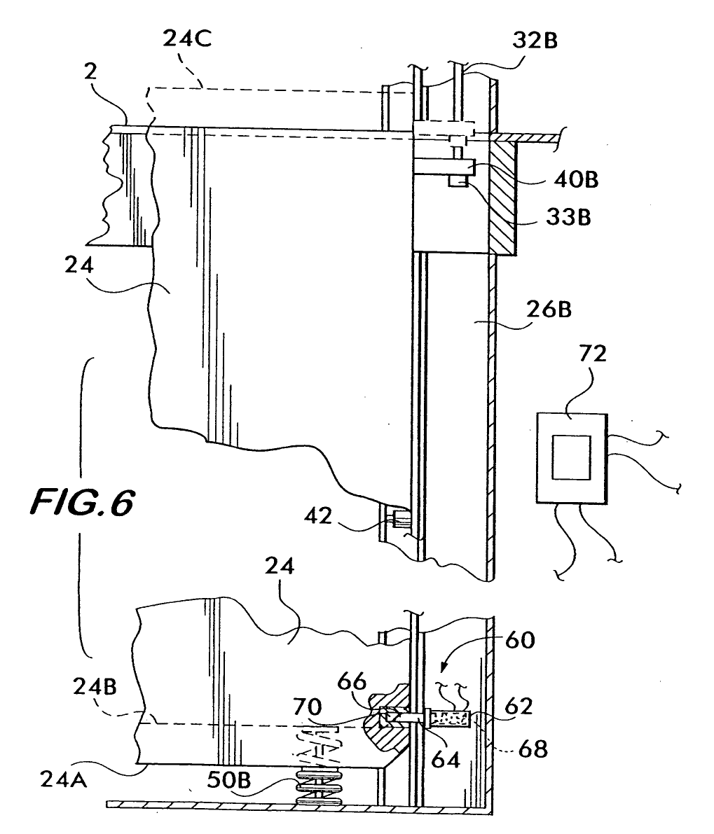

Another alternative is depicted in FIG. 6. In this embodiment, a latching mechanism 60 is provided within the door assembly 20. In particular, the latching mechanism 60 comprises a solenoid 62 having a ram 64 with a tapered end 66 that is biased by a spring 68. The movable door 24 comprises a cavity 70 for receiving the ram 64. Thus, when the door 24 is moved downward into the door channel 28, the bottom edge (shown by reference number 24B) of the door 24 comes to rest against the springs 50A and 50B. This results in the upper edge (shown by reference number 24C) of the door 24 being raised slightly out of floor level 2. The user can now grasp the upper edge 24C of the door 24 and position it at the desired location. Conversely, if the user wants to conceal the door 24 completely beneath the floor level 2, he/she steps on the upper edge 24C to compress the lower edge 24A of the door 24 against the springs 50A and 50B. As the springs 50A/50B are compressed, the cavity 70 opening rides against the tapered end 66 of the ram 64 and once the cavity 70 and ram 64 are aligned, the spring 68 forces the ram 64 into the cavity 70, thereby latching the door 24 at that location. The door 24 is now completely concealed beneath the floor 2. To release the latching mechanism 60, a switch 72 is electrically coupled (or wirelessly coupled) to the solenoid 62. The user depresses the switch 72 and that retracts the ram 64 out of the cavity 70, thereby allowing the springs 50A/50B to drive the door 24 upward so that the upper edge of the door (see 24C) is exposed from the floor 2. The user can then position the door 24 where desired. It should be noted that the switch 72 can be positioned at any desired level (e.g., at foot level in case the user's hands are full, although it is preferable to keep it away from the reach of children, e.g., arm level) to allow the user to easily operate and release the latch mechanism 60. It should also be noted that this latch mechanism 60 is by way of example only and is not limited to what is shown. Furthermore, the door assembly 20 could be inverted and suspended from the attic, or higher floor, and the latch mechanism 60 would operate similarly with the user pushing the door 24 upward to latch it, and thereby conceal it in the ceiling above.

Furthermore, it should be understood that where a control panel or switch (e.g., control panel P or switch 72) is provided, it is available on both sides of the door assembly 20; that is, with the door 24 separating two rooms or locations, there is a control panel or switch in each room (or location) that shares the door 24 to allow control of the door 24 from either room or location.

Although not shown, it is within the broadest scope of the present invention 20 to include a lock mechanism within the door track unit 22 to prevent the moveable door 24 from moving once it is positioned where the intent is to prevent entry or exit from a room. Thus, just as a typical hinged door can be locked or unlocked (e.g., a cylindrical lock, mortise lock, deadbolt lock, etc.) so too can the moveable door 24.

While the invention has been described in detail and with reference to specific examples thereof, it will be apparent to one skilled in the art that various changes and modification can be made therein without departing from the spirit and scope of thereof.

What is claimed is:

1. A door assembly adapted for installation in a structure having an upper floor and a lower floor, said door assembly comprising:
a housing that extends between the upper floor and the lower floor and anchored to the structure; and
a door that is displaceable within said housing so that it can be moved between the upper floor and the lower floor.

2. The door assembly of claim I wherein said door assembly further comprises:
said housing having a door channel and a first side channel parallel to said door channel; and
a first pulley and first cable disposed in said first side channel, said first pulley being secured in said first side channel and able to rotate to displace two ends of said first cable in opposite directions, said first cable having a first weight coupled to one of said ends and a first coupling member coupled to the other one of said ends, said first coupling member being fixedly secured to said door.

3. The door assembly of claim 2 wherein said door assembly comprises:
a second side channel parallel to said door channel and opposite said first side channel; and
a second pulley and second cable disposed in said second side channel, said second pulley being secured in said second side channel and able to rotate to displace two ends of said second cable in opposite directions, said second cable having a second weight coupled to one of said ends and a second coupling member coupled to the other one of said ends, said second coupling member being fixedly secured to said door.

4. The door assembly of claim 3 wherein said first and second pulley are coupled together using a common axle.

5. The door assembly of claim 3 wherein said housing further comprises a plurality of rollers disposed in said door channel and on opposite sides of said door.

6. The door assembly of claim 3 wherein said housing further comprises rub rails along a portion of said door channel against which said coupling members move.

7. The door assembly of claim 3 wherein said housing comprises a plurality of springs disposed in a bottom of said housing.

8. The door assembly of claim 4 further comprising a motor having a clutch interfaced with said common axle, said motor and clutch rotating said common axle when energized.

9. The door assembly of claim 8 further comprising a control panel electrically coupled to said motor and clutch, said panel permitting a user to activate said motor.

10. The door assembly of claim 9 wherein said control panel comprises a first button to move said door upward and a second button to move said door downward.

11. The door assembly of claim 8 further comprising a voice activator to energize said motor.

12. The door assembly of claim 5 further comprising a foot activated switch to energize said motor.

13. The door assembly of claim 7 further comprising a latching mechanism, said latching mechanism permitting said movable door to be releasably latched in a concealed position.

14. The door assembly of claim 13 further comprising a switch to activate said latching mechanism to expose said door from said concealed position.

15. A method for providing a vertically moving door in a structure, said method comprising the steps of:
providing a housing having a door that is slidable therein; and
installing said housing between an upper floor of a structure and a lower floor of the structure.

16. The method of claim 15 wherein said step of providing a housing having a slidable door therein comprises:
providing a door channel and a first side channel parallel to said door channel in said housing;
securing a first pulley in said first side channel and which is able to rotate to displace two ends of a first cable in opposite directions;
securing a first weight to one of said ends of said first cable and securing a first coupling member to the other one of said ends; and
securing a first side of said door to said first coupling member.

17. The method of claim 16 wherein said step of providing a housing having a slidable door therein further comprising the steps of:
providing a second side channel parallel to said door channel, and opposite said first side channel, in said housing;
securing a second pulley in said second side channel and which is able to rotate to displace two ends of a second cable in opposite directions;
securing a second weight to one of said ends of said second cable and securing a second coupling member to the other one of said ends; and
securing a second side of said door to said second coupling member.

18. The method of claim 17 further comprising the step of coupling said first and second pulleys to a common axle.

19. The method of claim 16 further comprising the step of positioning a plurality of rollers in said door channel, on opposite sides of said door, to facilitate vertical movement of said door in said door channel.

20. The method of claim 17 further comprising the step of providing rub rails along a portion of said door channel against which said first and second coupling members move.

21. The method of claim 16 further comprising the step of positioning a plurality of springs in a bottom of said housing.

22. The method of claim 18 further comprising the step of interfacing a motor having a clutch with said common axle, said motor and clutch operating to assist rotating said common axle when said motor is energized.

23. The method of claim 20 further comprising the step of associating a control panel with said motor, said control panel permitting a user to activate said motor.

24. The method of claim 21 wherein said step of associating a control panel with said motor further comprises providing a first button to move said door upward and a second button to move said door downward.

25. The method of claim 21 wherein said step of associating a control panel with said motor comprises providing a voice activator to energize said motor.

26. The method of claim 21 wherein said step of associating a control panel with said motor comprises providing a foot activated switch to energize said motor.

27. The method of claim 21 further comprising the steps of providing a latching mechanism that releasably latches said door in a concealed position.

28. The method of claim 21 further comprising the step of providing a switch for activating said latching mechanism to expose said door from said concealed position.
